(19) United States
(12) Patent Application Publication
(10) Pub. No.: US 2005/0255362 A1
(43) Pub. Date: Nov. 17, 2005

(54) Fuel cell and related manufacturing method

(75) Inventor: Atsushi Miyazawa, Kanagawa (JP)

Correspondence Address: FOLEY AND LARDNER;SUITE 500, 3000 K STREET NW, WASHINGTON, DC, 20007, US

(73) Assignee: NISSAN MOTOR CO., LTD

(21) Appl. No.: 10/520,517

(22) PCT Filed: Dec. 11, 2003
(86) PCT No.: PCT/JP03/15860

§ 371 Date: Jan. 7, 2005

(51) Int. Cl. H01M 2/08

(52) U.S. Cl. 429/35

(57) ABSTRACT

A fuel cell includes an electrode membrane structural body (5) and a pair of separators (9, 9) between which the electrode membrane structural body is sandwiched. The electrode membrane structural body includes an electrolyte membrane (1) and a pair of gas diffusion layers (3, 3) formed on both surfaces of the electrolyte membrane and serving as electrodes. Each of the pair of separators has gas flow channels (13) to allow gas to be supplied to associated one of the gas diffusion layers. A porosity of the associated one of the pair of gas diffusion layers at an area outside the gas flow channels is lower than that at an area facing the gas flow channels.

### TECHNICAL FIELD

The present invention relates to a fuel cell and a related method, and more particularly to a polymer electrolyte fuel cell (and a related method.

### BACKGROUND ART

A fuel cell serves to allow fuel gas, containing hydrogen, and oxidative gas, such as air containing oxygen, to electrochemically react with one another through an electrolyte to take out electrical energy from electrodes formed on both surfaces of the electrolyte. A fuel cell powered vehicle equipped with such a fuel cell is one which is installed with a hydrogen storage device such as a high pressure hydrogen tank, a liquid hydrogen tank and a hydrogen absorbing alloy tank to allow resulting hydrogen gas and air containing oxygen to be delivered to a fuel cell for reaction for thereby taking out electric energy by which a motor connected to drive wheels is driven, with exhausted substance being water to create a clean vehicle.

Especially, PEFC, which has a solid polymer electrolyte, operates at a low temperature while providing an ease of handling and, hence, PEFC is focused on attention as an electric power supply of an electrically powered vehicle.

A cell forming an electric power generation unit of PEFC takes the form of a structure wherein an electrode membrane structural body, constructed of a solid polymer electrolyte membrane and, an anode gas diffusion layer and a cathode gas diffusion layer that are formed on both sides of the solid polymer electrolyte membrane is sandwiched between a pair of separators.

Japanese Patent Application Laid-Open Publication No. 2001-319667 relates to a gas diffusion layer, a separator and a gasket in a cell of a fuel cell and contemplates to restrict a gap between the gas diffusion layer and the gasket surrounding the gas diffusion layer for thereby improving a sealing property between the gas diffusion layer and a gasket portion of the gasket.

### DISCLOSURE OFINVENTION

However, according to studies conducted by the present inventor, while depending on the fuel cell with such a structure, an improvement in performance can be expected by decreasing the gap to the minimum between the gas diffusion layer and the gasket located at the outside the gas diffusion layer, it is conceivable that due to the gas diffusion layer per se being porous, reaction gas flows through the interior of the gas dispersing layer disposed between the gas flow channels, formed in the separator, and the gasket with no contribution to electric power generation. This leads to the occurrence in which a portion of gas supplied to a gas inlet of the separator wastefully flows to a gas outlet without contributing to electric power generating reaction with a resultant drop in an electric power generating efficiency.

Further, with such a cell structure, when locating the gas diffusion layer on the separator, because of the reason that the gas diffusion layer should entirely cover the gas flow channel region formed on the separator and it is necessary for the gas diffusion layer per se to be accurately positioned, it is considered that there are many probabilities in which the gas diffusion layer must be set to be larger than the reacting area.

FIG. 8 is a partial cross sectional view schematically illustrating a structure of a fuel cell 80 which is also described later in conjunction with a Comparative Example and is studied based on such a structure. Also, for the sake of convenience of description, only one unit cell of the fuel cell 80 is shown in an exploded status.

As shown in FIG. 8, an electrode membrane structural body 105 is comprised of an electrolyte membrane 101 and two gas diffusion layers 103, 103 formed on both surfaces of the electrolyte membrane 101. The electrode membrane structural body 105 is sandwiched between the separators 109, 109, that is, a cathode separator 109a and an anode separator 109b, and a gasket 107 is disposed between the electrode membrane structural body 105 and each of the separators 109a, 109b.

Here, it is conceived that a distance (shortest distance) L between the gas flow channels 113, on each of the separators 109a, 109b, and the gasket 107 is set to a value in the order of several millimeters to provide a non-reacting region for precluding gas from flowing through an area outside the reacting region without reaction.

In the meanwhile, since a width of each gas flow channel lies in a value in the order of several millimeters, such a non-reacting region lies in at least a width greater than that of each gas flow channel and thus a surface area of the reacting region is inevitably caused to decrease by such an extent. This leads to a drop in output power of the fuel cell in the first place. Moreover, even if such a non-reacting region is provided, it becomes hard to improve flow control of gas passing through the porous gas diffusion layer.

The present invention has been made upon such studies conducted by the present inventor and particularly has an object to provide a fuel cell, which has a structure made of gas diffusion layers, gaskets and separators wherein introduced gas is prevented from wastefully flowing through an area outside a reacting region to allow introduced gas to be entirely and efficiently subjected to reaction, and a related method.

According to one aspect of the present invention, a fuel cell comprises: an electrode membrane structural body provided with an electrolyte membrane; and a pair of gas diffusion layers formed on both surfaces of the electrolyte membrane and serving as electrodes, respectively; and a pair of separators between which the electrode membrane structural body is sandwiched, each of the pair of the separators having gas flow channels that allow gas to be supplied to associated one of the pair of gas diffusion layers, and a porosity of the associated one of the pair of gas diffusion layers at an area outside the gas flow channels is lower than a porosity of the associated one of the pair of gas diffusion layers at an area facing the gas flow channels.

In other word, according to another aspect of the present invention, a fuel cell comprises: an electrode membrane structural body provided with: an electrolyte membrane; and a pair of gas diffusion layers formed on both surfaces of the electrolyte membrane and serving as electrodes, respectively; a pair of separators between which the electrode membrane structural body is sandwiched, each of the pair of the separators having gas flow channels that allow gas to be supplied to associated one of the pair of gas diffusion layers; and lowering means for lowering a porosity of the associated one of the pair of gas diffusion layers at an area outside the gas flow channels than a porosity of the associated one of the pair of gas diffusion layers at an area facing the gas flow channels.

In the meanwhile, according to another aspect of the present invention, there is provided a method of manufacturing a fuel cell, which method comprises: preparing an electrode membrane structural body provided with: an electrolyte membrane; and a pair of gas diffusion layers formed on both surfaces of the electrolyte membrane and serving as electrodes, respectively, and sandwiching the electrode membrane structural body between a pair of separators each of which has gas flow channels that allow gas to be supplied to associated one of the pair of gas diffusion layers, a porosity of the associated one of the pair of gas diffusion layers at an area outside the gas flow channels being lower than a porosity of the associated one of the pair of gas diffusion layers at an area fig the gas flow channels.

Other and further features, advantages, and benefits of the present invention will become more apparent from the following description taken in conjunction with the following drawings.

### BRIEF DESCRIPTION OF DRAWINGS

FIG. 1 is a partial cross sectional view schematically showing a fuel cell of a first embodiment according to the present invention;

FIG. 2 is a partial cross sectional view schematically showing a fuel cell of a second embodiment according to the present invention;

FIG. 3 is a partial cross sectional view schematically showing a fuel cell of a third embodiment according to the present invention;

FIG. 4 is a partial cross sectional view schematically showing a fuel cell of a fourth embodiment according to the present invention;

FIG. 5 is a partial cross sectional view schematically showing an electrode membrane structural body of a fuel cell of a fifth embodiment according to the present invention;

FIG. 6 is a view showing a characteristic of a gas diffusion layer in terms of a surface pressure encountered representatively in the first embodiment of the present invention;

FIG. 7 is a characteristic of electric voltage in terms of electric current showing experimental results of the first and fourth embodiments of the present invention and a Comparative Example; and

FIG. 8 is a partial cross sectional view schematically showing a structure of a fuel cell of the Comparative Example.

### BEST MODE FOR CARRYING OUT THE INVENTION

A fuel cell and a related method of each of embodiments according to the present invention and a Comparative Example are described hereunder in detail with suitable reference to the accompanying drawings.

### FIRST EMBODIMENT

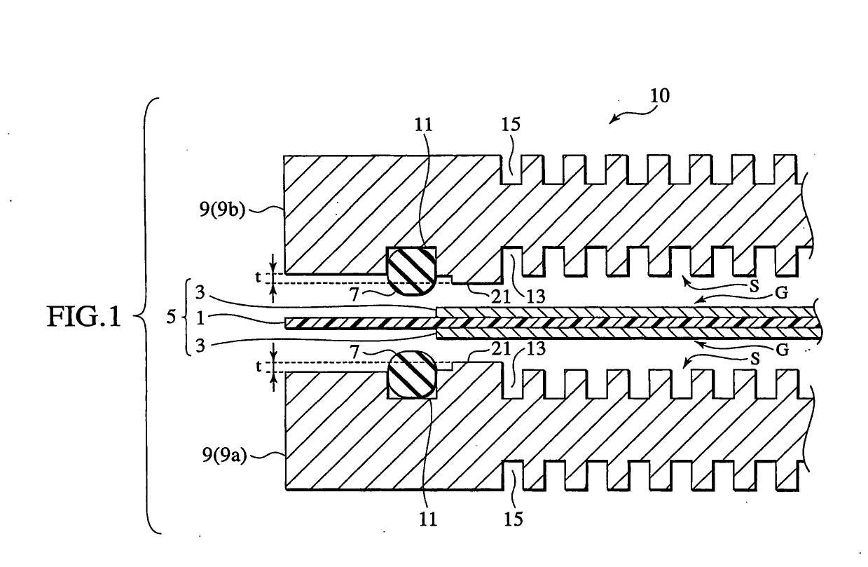

First, referring mainly to FIG. 1, a fuel cell 10 and its related method of a first embodiment according to the present invention are described in detail. Incidentally, for the sake of convenience of description, only one unit cell of the fuel cell 10 is shown in an exploded status. Further, the unit cell of the fuel cell 10, shown in the presently filed embodiment, is of a structure which has a reacting region G with a surface area of 150 mm×150 mm and separators each formed of a graphite plate, with a size of 200 mm×200 mm×2.5 mm, which is formed with gas flow charnels and coolant flow channels, with an electrolyte membrane and a gas diffusion layer having thickness of 30 μm and 280 μm, respectively.

As shown in FIG. 1, an electrode membrane structural body 5 is formed of an electrolyte membrane 1 and two gas diffusion layers 3, 3 formed on both surfaces of the electrolyte membrane 1. The gas diffusion layers 3, 3 are made of porous members each having pores, with one of the diffusion layers serving as an anode electrode supplied with fuel gas containing hydrogen while the other gas diffusion layer serves as a cathode electrode supplied with oxidative gas (oxidizer gas) such as air containing oxygen.

Gaskets 7, 7 are interposed between the electrode membrane structural body 5 and the separators 9, 9 (one of which is a cathode separator 109a and the other of which is an anode cathode separator 109b) to preferably make a round at an interface area therebetween while the electrode membrane structural body 5 is sandwiched at both sides thereof between the separators 9, 9, thereby forming the fuel cell 10 in the form of the unit cell.

More particularly, each separator 9 has a main surface formed with recess-like gas flow channels 13 by cutting and has the other surface, opposite to the main surface, formed with coolant flow channels 15 by cutting. Gasket recesses 11 are formed on the respective separators at further outer areas than that in which the gas flow channels 13 are formed.

Further, formed on each separator 9 in contact with the outermost end portion of the gas flow channels 13 is a convex portion 21 that protrudes from the main surface of the separator 9 toward the electrode membrane structural body 5 by a height t The convex portion 21 is formed in a way to make a round on the separator 9 at an area further inside than a terminal portion of the gas diffusion layer 3 of the electrode membrane structural body 5. That is, an area in which the convex portion 21 is fanned may be sufficient to be set at a position between the outermost end portion of the gas flow channel 13 and the gasket 7 such that the convex portion 21 surrounds a gas flow channel placement region S, in which the gas flow channels 13 are formed, as viewed in a direction parallel to a page surface (as viewed from the above in FIG. 1).

Here, the porous member for use in each gas diffusion layer 3 is used in a status with an appropriate porosity as a result of compression executed in a direction of a thickness of the cell during assembly of the fuel cell 1 and also with a required conductivity.

FIG. 6 is a view showing the relationship between a surface pressure of each gas diffusion layer 3 and a thickness thereof in the presently filed embodiment. In the figure, the abscissa axis represents the surface pressure p of the gas diffusion layer 3 and the ordinate axis represents the thickness t_{D} of the gas diffusion layer 3. Incidentally, such a relationship is similar in each of the embodiments 1 to 5.

As shown in FIG. 6, it is understood that as the surface pressure p exerted to each gas diffusion layer 3 gradually increases, the pores in this component are crushed to cause the thickness t_{D} of the gas diffusion layer 3 to be thinned and as the gas diffusion layer 3 becomes thinner, the porosity the gas diffusion layer 3 decreases.

More particularly, the porous gas diffusion layer 3 exhibits a tendency in that although during a time interval in which the surface pressure p remains low, the thickness t_{D} of the gas diffusion layer decreases in inverse proportion to an increase in the surface pressure p, a further increase in the surface pressure p results in a decrease in the thickness to with a smaller decreasing rate. And, as the surface pressure p exceeds a certain value of B, the gas diffusion layer 3 finishes crushing whereby a tendency appears in that even when the surface pressure p is further increased, almost, no variation takes place in the thickness t_{D}.

Here, it is supposed that in the porous gas diffusion layer 3, the surface pressure A is exerted to the gas diffusion layer 3 at the reacting region (electric power generating region) G corresponding to the gas flow channel placement region S and the thickness reaches a value of t_{A}.

However, at the convex portion 21 of the separator 9, the gas diffusion layer 3 is compressed in excess by a height t (in particular, t is set to 30 μm) and, as a result the gas diffusion layer 3 has a thickness equal to a value of t_{A}−t at an area against which the convex portion 21 abuts.

Accordingly, the gas diffusion layer 3 facing the convex portion 21 is sufficiently compressed to a further extent than that of the reacting region G facing the gas flow channel placement region S in which the gas flow channels 13 are located, resulting in a lower porosity than that of the reacting region. Incidentally, the amount of the gas diffusion layer 3 to be compressed is preferred to lie at an extent in that a pressure loss of gas flowing through an area of the gas diffusion layer 3 correspondingly located outside the gas flow channels 13 is larger than a pressure loss of gas flowing through the other area of the gas diffusion layer 3 remaining in the reacting region G More preferably, it is good for the porous structure of the area of the gas diffusion layer 3 correspondingly located outside the gas flow channels 13 to have a thickness t_{B}, at which crushing of the gas diffusion layer 3 fishes at an extent not to allow gas to flow. Also, a width or the like of the convex portion 21 may be suitably altered depending on the surface pressure p resulting when the convex portion 21 abuts against the gas diffusion layer 3.

Further, since the convex portions 21 of both the separators 9 for the anode and the cathode are disposed in symmetry with respect to the electrolyte membrane 1 (symmetric with respect to the surface of the electrolyte membrane 1 extending perpendicular to the page surface of FIG. 1), the gas diffusion layers 3 are equally compressed on both sides of the electrolyte membrane 1, thereby enabling adjustments so as to decrease the porosities of the gas diffusion layers 3. That is, it is possible to accomplish adjustments so as to decease the porosities of the gas diffusion layers 3 without causing the electrolyte membrane 1 from being distorted due to excessive external forces.

With the structure of the presently filed embodiment set forth above, due to an ability of suppressing the occurrence in which a portion of introduced reaction gas does not flow along the gas flow channels formed on the separators and flows in the gas diffusion layers at an area apart from the reacting region, a substantially entire part of introduced gas can be reacted, resulting in a capability of improving a performance of the fuel cell.

Furthermore, in contrast to a method wherein the terminal portions of the porous members are concealed with resin, with the presently filed embodiment, once the height of the convex portion with respect to the main surface of the separator is determined, the separator can be efficiently fabricated by such as press forming without a need for any wasteful time and extra expenses.

Incidentally, of course, no limitation is intended to the number of pieces of the unit cells, dimensions and configurations of the particular arrangements to be used in the presently filed embodiment, and it is, of course, possible to apply other conditions to the fuel cell of the presently filed embodiment provided that similar functions are obtained.

### SECOND EMBODIMENT

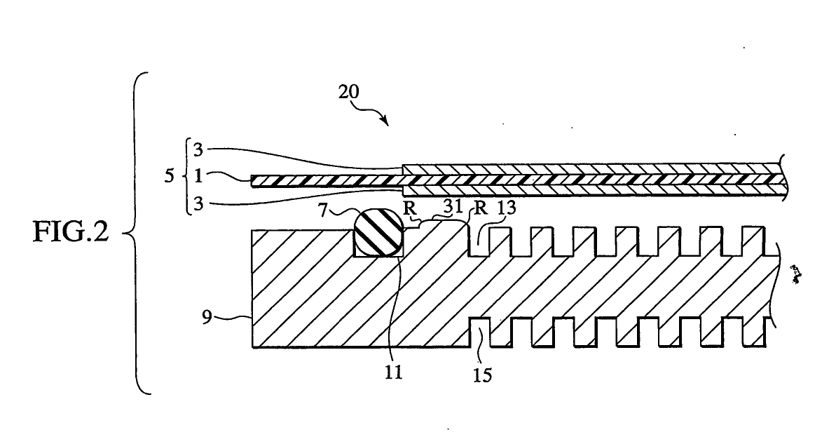

Next, referring mainly to FIG. 2, a fuel cell 20 and its related method of a second embodiment according to he present invention are described in detail. Also, for the sake of convenience of description, only one unit cell of the fuel cell 20 is shown in an exploded status, with only one of two separators 9, 9 for the anode and the cathode placed in surface symmetry with respect to the electrode membrane structural body 5 being illustrated Also, the same component parts as those of the first embodiment bear the same reference numerals and description is suitably simplified or omitted.

As shown in FIG. 2, the presently filed embodiment differs from the first embodiment in that, in contrast to the convex portion 21 of the first embodiment shown in FIG. 1, a convex portion 31 has a shape in which corner portions (edge portions) are formed with round configurations R, respectively, and both embodiments are identical in other structure.

With the structure of the presently filed embodiment, due to the edge portions being removed from the convex portion 31 with the round configurations R, even if the gas diffusion layer 3 is made of a fragile porous member such as a carbon paper, it is possible to avoid the gas diffusion layer 3 from being deteriorated in function due to cracks or the like caused in the member.

Additionally, due to the presence of reduction in a surface contact area of the gas diffusion layer as compared to that of the first embodiment, even if the fuel cell stack is exerted with and compressed by the same magnitude of load as that exerted to the fuel cell stack in the first embodiment, the gas diffusion layer 3 undergoes a further increased load at a portion facing the convex portion 31, enabling that portion to have a further decreased porosity.

### THIRD EMBODIMENT

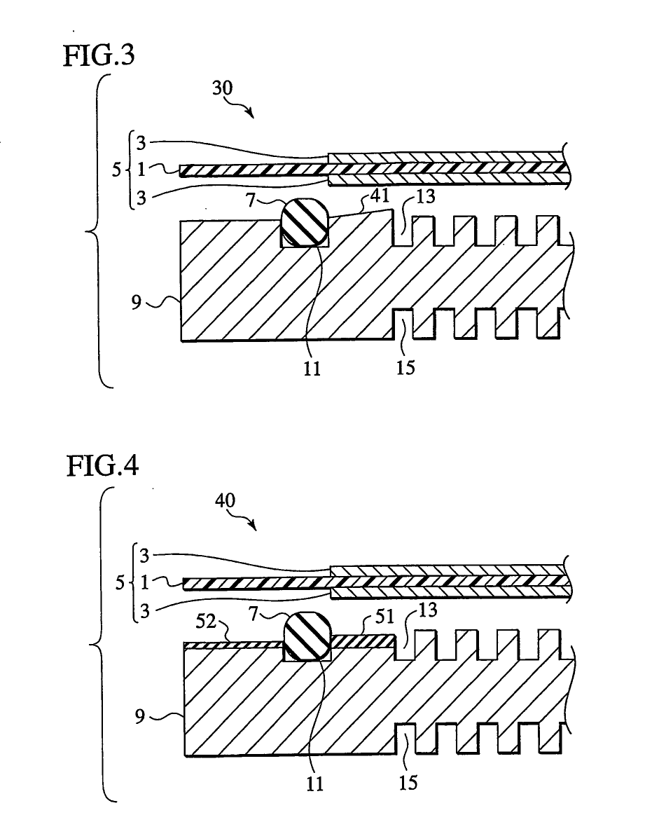

Next, referring mainly to FIG. 3, a fuel cell 30 and its related method of a third embodiment according to the present invention are described in detail. Also, for the sake of convenience of description, only one unit cell of the fuel cell 30 is shown in an exploded status, with only one of two separators 9, 9 for the anode and the cathode placed in surface symmetry with respect to the electrode membrane structural body 5 being illustrated. Also, the same component parts as those of the first embodiment bear the same reference numerals and description is suitably simplified or omitted.

As shown in FIG. 3, the presently filed embodiment differs from the first embodiment in that, in contrast to the convex portion 21 of the first embodiment shown in FIG. 1, a convex portion 41 has a sloped surface with a height differing between an area closer to the gas flow channels 13 and the other area closer to the gasket 7 such that a surface facing the gas diffusion layer 3 has a lower height at an area closer to the gasket 7 than that of the other, and the residual structure is identical as that of the first embodiment. Also, in the presently filed embodiment, the gas diffusion layer 3 is made of a carbon cloth that is formed in a porous member.

With the structure of the presently filed embodiment, the presence of the highest portion of the convex portion 41 being located closer to the gas flow channels 13 enables the gas diffusion layer 3 to be collectively exerted with the load, thereby enabling introduced reaction gas to be further effectively avoided from flowing out from the gas flow channels 13 toward an area closer to the gasket 7.

### FOURTH EMBODIMENT

Next, referring mainly to FIG. 4, a fuel cell 40 and its related method of a fourth embodiment according to the present invention are described in detail. Also, for the sake of convenience of description, only one unit cell of the fuel cell 40 is shown in an exploded status, with only one of two separators 9, 9 for the anode and the cathode placed in surface symmetry with respect to the electrode membrane structural body 5 being illustrated. Also, the same component parts as those of the first embodiment bear the same reference numerals and description is suitably simplified or omitted.

As shown in FIG. 4, the presently filed embodiment differs from the first embodiment in that the convex portion 21, such as the one of the first embodiment shown in FIG. 1, is not provided whereas an insulation member 51 is disposed inside the gasket 7 to have a flat surface facing the gas diffusion layer 3 and an insulation member 52 is disposed outside the gasket 7 to have a flat facing the gas diffusion layer 3 such that the gasket 7 is sandwiched by the insulation member 51 and the insulation member 52, and the residual structure is identical as the structure of the first embodiment.

More particularly, a thickness of the insulation member 52 disposed outside the gasket 7 is set to be equal to a thickness of the gas diffusion layer 3 in a case where a unit cell is exerted with a predetermined load. Moreover, the thickness of the insulation member 51 disposed inside the gasket 7 is set in the same way as that used in the first embodiment with reference to FIG. 6.

Such insulation members 51, 52 also have functions to prevent the anode separator and the cathode separator from being short-circuited in the unit cell and may preferably have heat-resistant properties in respect of an operating temperature (in the vicinity of 100° C.) of the fuel cell, hydrolysis-resistant properties in respect of humidifying operation and acid resisting properties derived from the electrolyte membrane, while no care need to be undertaken to employ any of thermosetting resin and thermoplastic resin.

Further, since the insulation members 51 are provided at the anode and cathode sides in surface symmetry with respect to the electrode membrane structural body 5, the gas diffusion layers 3 of the electrode membrane structural body 5 are equally compressed, thereby enabling the porosity to be decreased for adjustment. That is, no probability occurs in which the electrolyte membrane 1 encounters distortion due to excessive external forces.

With the structure of the presently filed embodiment, thus, in contrast to a situation to be conceivable where although the gas diffusion layer is compressed to a certain specified value in use, this results in a difference in the degree of compression of the gas diffusion layer depending on how the load is exerted thereto to cause a difference in the degree of gas diffusion with a resultant increased inequality in performances of the unit cells, the insulation members between the electrode membrane structural bodies are used as thickness adjusting members for the gas diffusion layers.

Accordingly, due to a capability of using the insulation members between the electrode membrane structural bodies as the thickness adjusting members for the gas diffusion layers, setting the thickness of the insulation layer to an extent equal to a compressed thickness of the gas diffusion layer, in order to enable a compressed extent of the gas diffusion layer to have a certain thickness however hard the gas diffusion layer is compressed, makes it possible to ensure all of the unit cells to have the gas diffusion layers each with a uniform thickness.

### FIFTH EMBODIMENT

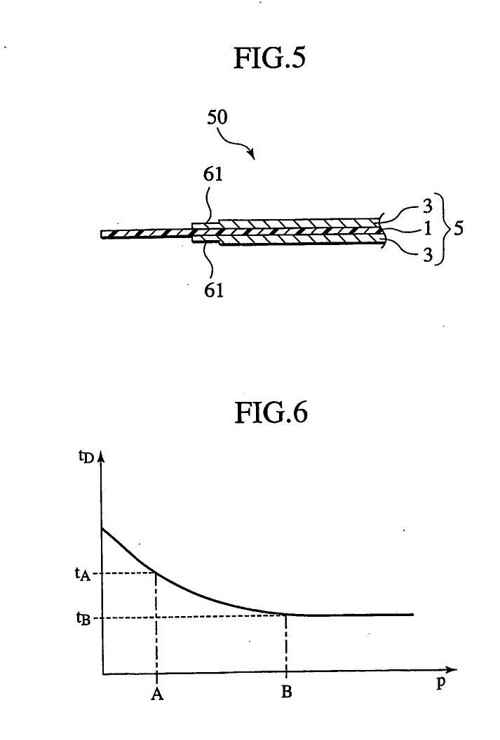

Next referring mainly to FIG. 5, a fuel cell 50 and its related method of a fifth embodiment according to the present invention are described in detail. Also, for the sake of convenience of description, only one electrode membrane structural body is shown. Also, the same component parts as those of the first embodiment bear the same reference numerals and description is suitably simplified or omitted.

As shown in FIG. 5, the electrode membrane structural body 50 is comprised of the electrolyte membrane 1 and two gas diffusion layers 3 formed on both sides of the electrolyte membrane 1.

More particularly, the gas diffusion layers 3 of the electrode membrane structural body 50 have respective end portions 61 that are formed by compressing the same in opposite directions (in vertically opposite directions in the figure) perpendicular to both of the main surfaces. And, the electrode membrane structural body 50 obtained as a result of such compression is applied to the structure of the first embodiment, thereby permitting the fuel cell to be assembled. Also, it is, of course, to be noted that the electrode membrane structural body 50 having such end portions 61 is available for application to the structures of the second to fourth embodiments.

When compressing the end portion 61, as seen in the compression curve shown in FIG. 6, it is preferable for the end portion 61 to be compressed to a thickness t_{B} until no further variation takes place in a thickness t_{D} of the gas diffusion layer 3. According to this feature, the load to be applied to the unit cells of the fuel cell to be assembled as a stack is sufficient to be only set such that the thickness t_{D} of the gas diffusion layer 3 equals t_{A}.

More particularly, methanol solution of thermosetting resin is prepared and impregnated in the gas diffusion layer 3 whereupon parts of the end portions 61 of the gas diffusion layers 3 are imparted with a load with a surface pressure of 2 MPa at a surrounding temperature of 120° C. by a compressing press for thereby hardening resin, thereby obtaining the gas diffusion layer 3 having the compressed end portions 61. Incidentally, it may be arranged such that the end portions 61 of the gas diffusion layers 3 are preliminarily formed in more increased thickness and, thereafter, the end portions 61 are compressed to obtain decreased porosities, while on the other hand, making an attempt to set each thickness corresponding to the electric power generating region to fail n a value of t_{A}. In such case, there is no need for forming the convex portions 21, 31, 41, 51 which are previously mentioned.

Further, since the compressed areas of the end portions 61 of the gas diffusion layers 3 are formed in surface symmetry with respect to the electrolyte membrane 1, the gas diffusion layers 3 are equally compressed with respect to the electrolyte membrane 1, obtaining decreased porosities. This enables the electrolyte membrane to be effectively avoided from suffering from distortion due to undesired external forces.

With the structure of the presently filed embodiment thus mentioned, the use of the gas diffusion layers, of the electrode membrane structural body, preliminarily compressed at the regions in which no contribution takes place for electric power generation, makes it possible to effectively avoid gas introduced to the fuel cell from flowing into a region which is unavailable in contribution to electric power generation.

### COMPARATIVE EXAMPLE

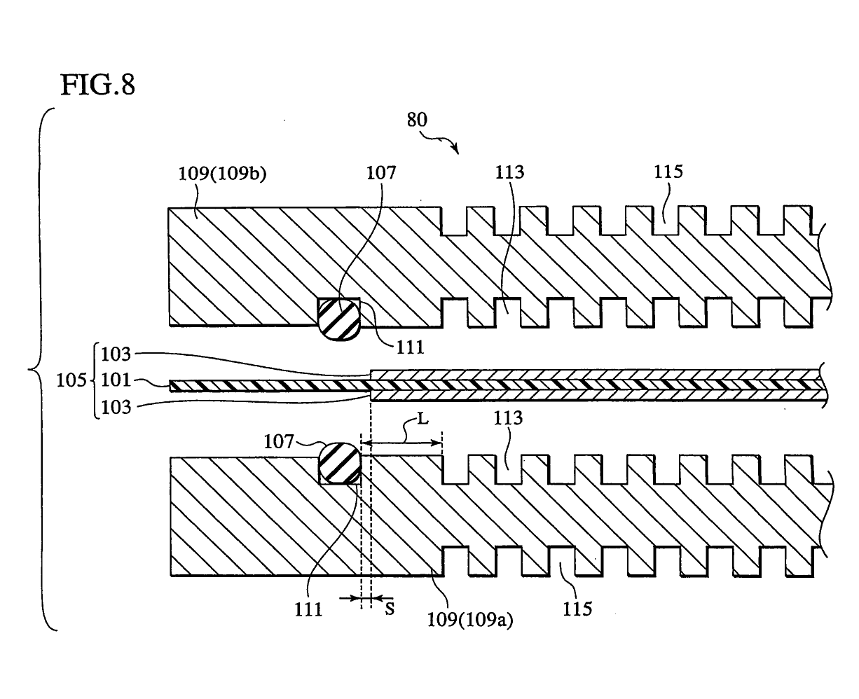

Next, referring mainly to FIG. 8, Comparative Example that was studied in the presently filed embodiment is described in detail Also, for the sake of convenience of description, only one unit cell of the fuel cell 80 is illustrated in the exploded status. Also, the same component parts as those of the first embodiment bear the same reference numerals and description is suitably simplified or omitted.

As shown in FIG. 8, in the present Comparative Example, the electrode membrane structural body 105 is comprised of the electrolyte membrane 101, and the two gas diffusion layers 103 formed on both sides of the electrolyte membrane 101. Disposed between the electrode membrane structural body 105 and the separators 109, 109, i.e., the cathode separator 109a and the anode separator 109b is the gasket 107, and the electrode membrane structural body 105 is sandwiched between the cathode separator 109a and the anode separator 109b. In this Comparative Example, the outermost distance L between the gas flow channel 13 and the gasket 107 is set to a value of 4.5 mm, and a spaces between the gas diffusion layer 103 and the gasket 107 is set to a value of 1.2 mm. And, the unit cell stack with such a condition is compressed at a surface pressure of 1.0 MPa, thereby obtaining a fuel cell that is stacked.

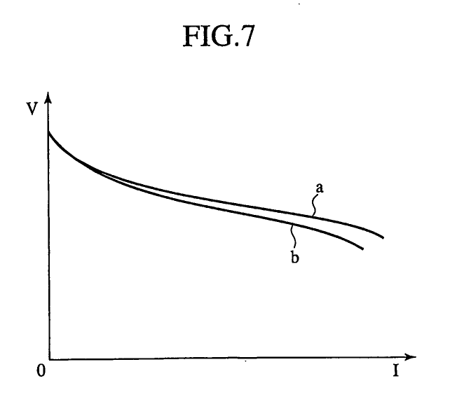

FIG. 7 is a view for typically showing an electric current voltage characteristic illustration showing experimental results obtained in respect of an I-V characteristic as a result of electric power generation of the fuel cells of the first and fourth embodiments of the present invention and the Comparative Example. In the figure, the abscissa axis represents electric current I, the ordinate axis represents electric voltage V, a curve a represents the I-V characteristic of the fuel cells 10, 40 of the first and fourth embodiments, and a curve b represents the I-V characteristic of the fuel cell 80 of the Comparative Example. Operating conditions of the respective fuel cells 10, 40, 80 were based on setting each cell temperature to 80° C., using hydrogen gas as reaction gas for the anode and air as reaction gas for the cathode and humidifying such that both hydrogen gas and air reach a steam content of 80% of saturated steam content at a cell temperature. Also, the gas diffusion layers 3, 103 are made of carbon papers.

As shown in FIG. 7, it is understood that the I-V characteristic of the fuel cells 10, 40 of the first and fourth embodiments are further improved than that of the fuel cell 80 of Comparative Example.

According to the structures of the respective embodiments of the present invention described above, since the porosity of the area, which is located outside the gas flow channels of the separator of the gas diffusion layer of the electrode membrane structural body is made smaller than the porosity of the area facing the gas flow channels, the amount of gas flowing through the gas diffusion layer at the area outside the gas flow channels to be unavailable in contribution to reaction can be restricted with a resultant advantageous effect to increase an efficiency of the fuel cell.

The entire content of a Patent Application No. TOKIJGAN 2002-382139 with a filing date of Dec. 27, 2002 in Japan is hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

### INDUSTRIAL APPLICATION

As set forth above, in the fuel cell and the related method of the present invention, the porosities of the gas diffusion layers of the electrode membrane structural body at the areas located outside the gas flow channels of the separators are set to be smaller than the porosities of the areas facing the gas flow channels. With such a structure, it becomes possible to restrict the amount of gas flowing through the gas diffusion layers at the arm outside the gas flow channels to be unavailable in contribution to reaction for thereby increasing an efficiency of the fuel cell, and therefore a wide range of application is expected involving a fuel cell powered automobile.

1. A fuel cell comprising:
an electrode membrane structural body provided with:
an electrolyte membrane; and
a pair of gas diffusion layers formed on both surfaces of the electrolyte membrane and serving as electrodes, respectively; and
a pair of separators between which the electrode membrane structural body is sandwiched, each of the pair of the separators having gas flow channels that allow gas to be supplied to associated one of the pair of gas diffusion layers, and a porosity of the associated one of the pair of gas diffusion layers at an area outside the gas flow channels is lower than a porosity of the associated one of the pair of gas diffusion layers at an area facing the gas flow channels.

2. The fuel cell according to claim 1, wherein each of the pair of separators has a convex portion formed at the area outside the gas flow channels.

3. The fuel cell according to claim 2, wherein the convex portion is held in pressured contact with the associated one of the pair of gas diffusion layers.

4. The fuel cell according to claim 2, wherein a corner of the convex portion is formed in a round portion.

5. The fuel cell according to claim 2, wherein the convex portion has a sloped surface angled with respect to the associated one of the pair of gas diffusion layers.

6. The fuel cell according to claim 5, wherein a height of the convex portion increases as the convex portion is close to the gas flow channels.

7. The fuel cell according to claim 2, wherein the convex portion surrounds the gas flow channels.

8. The fuel cell according to claim 2, further comprising a gasket intervening between each of the pair of separators and the associated one of the pair of gas diffusion layers,
wherein the convex portion is positioned between the gas flow channels and the gasket.

9. The fuel cell according to claim 1, further comprising a pressing member intervening between the electrode membrane structural body and each of the pair of separators to press the associated one of the pair of gas diffusion layers.

10. The fuel cell according to claim 9, wherein the pressing member presses the associated one of the pair of gas diffusion layers at the area outside the gas flow channels.

11. The fuel cell according to claim 9, wherein the pressing member includes an electrically insulating member.

12. The fuel cell according to claim 9, further comprising a restricting member that restricts the pressing member.

13. The fuel cell according to claim 12, further comprising a gasket intervening between each of the pair of separators and the associated one of the pair of gas diffusion layers,
wherein the restricting member is located at an area outside the pressing member with the gasket being located therebetween.

14. The fuel cell according to claim 1, wherein the associated one of the pair of gas diffusion layers at the area outside the gas flow channels is preliminary compressed.

15. The fuel cell according to claim 1, wherein the porosity of the associated one of the pair of gas diffusion layers is distributed in surface symmetry with respect to the electrolyte membrane.

16. A fuel cell comprising:
an electrode membrane structural body provided with:
an electrolyte membrane; and
a pair of gas diffusion layers formed on both surfaces of the electrolyte membrane and serving as electrodes, respectively;
a pair of separators between which the electrode membrane structural body is sandwiched, each of the pair of the separators having gas flow channels that allow gas to be supplied to associated one of the pair of gas diffusion layers; and
lowering means for lowering a porosity of the associated one of the pair of gas diffusion layers at an area outside the gas flow channels than a porosity of the associated one of the pair of gas diffusion layers at an area facing the gas flow channels.

17. A method of manufacturing a fuel cell, comprising:
preparing an electrode membrane structural body provided with:
an electrolyte membrane; and
a pair of gas diffusion layers formed on both surfaces of the electrolyte membrane and serving as electrodes, respectively; and
sandwiching the electrode membrane structural body between a pair of separators each of which has gas flow channels that allow gas to be supplied to associated one of the pair of gas diffusion layers, a porosity of the associated one of the pair of gas diffusion layers at an area outside the gas flow channels being lower than a porosity of the associated one of the pair of gas diffusion layers at an area facing the gas flow channels.
